(19) United States
(12) Patent Application Publication
(10) Pub. No.: US 2021/0254654 A1
(43) Pub. Date: Aug. 19, 2021

(54) LOW PROFILE FASTENER ASSEMBLY

(71) Applicant: Engineered Components Company, Elgin, IL (US)

(72) Inventor: Arne Henriksen, JR., Algonquin, IL (US)

(21) Appl. No.: 16/793,760

(22) Filed: Feb. 18, 2020

(51) Int. Cl. F16B 37/14

(52) U.S. Cl. CPC F16B 37/145; F16B 33/004

(57) ABSTRACT

A fastener assembly for securing at least two materials together with a screw having an externally threaded shank and an enlarged head, and a nut having a shank with a blind hole therein. The blind hole being internally threaded to threadingly receive the externally threaded shank of the screw. The nut having an enlarged head on an end of the shank opposite from an end with an opening of the blind hole. The enlarged head of the nut having an outer surface and an inner surface. A sealing member may be disposed around the shank of the nut. The shank of the nut extends out of and away from the inner surface of the enlarged head of the nut, and the inner surface may include a depression surrounding the shank. The nut has a plated outer surface.

### FIELD OF THE INVENTION

The present invention relates to a fastener assembly, and in particular to a fastener assembly including a nut with a low-profile head and an internally threaded shank. A shank of a threaded screw is received in the internally threaded shank of the nut.

### BACKGROUND OF THE INVENTION

In some uses of fastener assemblies, such as in the construction of wall panels for truck bodies, stronger, lighter and thinner materials are being used which have been posing problems for existing fasteners. As the panels and extrusions to be joined together become thinner, their combined thickness becomes smaller than the length of the screw of the fastener assembly, which has a predetermined minimum length due to fabrication limitations. This causes the screw to protrude through the surface of the materials being joined. When this occurs, the screw cannot be tightened completely into the nut because the screw bottoms out on the bottom of the blind hole in the nut before the head of the nut and the head of the screw tightly clamp the plies of the panels together.

U.S. Pat. No. 8,434,982 provides a fastener assembly with an encapsulated head for use in thin wall assemblies. While presumably effective for its intended purpose, the encapsulated head may be undesirable in certain situations. For example, if a graphical sheet or overlay is located on top of the heads, the portions of the overlay above the heads may prematurely wear down.

Additionally, in some instances, the encapsulated heads are the components that define the maximum width of the truck at the bottom rail. Thus, if a truck enters a tight space when backing into a dock, on an angle, many times, it rubs against a structure which can rip off or damage the bottom rail scuff plate that is designed for possible slight contact.

Consequently, it can be seen that the need exists for a fastener assembly that with a thinner head and that is configured to be used in a thin wall assembly without damaging the wall assembly.

### SUMMARY OF THE INVENTION

In an embodiment, the present invention provides a fastener assembly that includes a thinner head that is sufficiently strong. Additionally, the present fastener assemblies include portions that are plated to withstand environmental forces.

Accordingly, in one or more aspects the present invention may be broadly characterized as providing a fastener assembly for securing at least two materials together having a screw having an externally threaded shank and an enlarged head, and a nut having a shank with a blind hole therein, and the blind hole internally threaded to threadingly receive the externally threaded shank of the screw. The nut has an enlarged head on an end of the shank opposite from an end with an opening of the blind hole, and the enlarged head of the nut has an outer surface and an inner surface. The shank of the nut extends out of and away from the inner surface of the enlarged head of the nut, and the inner surface comprises a depression surrounding the shank.

It is contemplated that the depression is an annular depression.

It is also contemplated that the shank comprises plurality of parallel longitudinal ridges extending parallel to a longitudinal axis of the shank. A sealing member may be disposed around the plurality of parallel longitudinal ridges. The sealing member may be an o-ring, a washer, or a pre-applied composite sealer.

It is further contemplated that at least the outer surface of the enlarged head of the nut comprises a plated surface.

In one or more aspects the present invention may also be broadly characterized as providing a fastener assembly for securing at least two materials having: a screw having an externally threaded shank and an enlarged head, and a nut having a shank with a blind hole therein, the blind hole internally threaded to threadingly receive the externally threaded shank of the screw. The nut has an enlarged head on an end of the shank opposite from an end with an opening of the blind hole, and the enlarged head of the nut has an outer surface and an inner surface. The shank of the nut extends out of and away from the inner surface of the enlarged head of the nut and the nut has a plated outer surface.

It is contemplated that the shank includes plurality of parallel longitudinal ridges extending parallel to a longitudinal axis of the shank. A sealing member may be disposed around the plurality of parallel longitudinal ridges. The sealing member may be an o-ring, a washer, or a pre-applied composite sealer.

It is also contemplated the inner surface comprises a depression surrounding the shank. The depression may be an annular depression.

In various aspects the present invention may also be broadly characterized as providing a fastener assembly for securing at least two materials together having: a screw having an externally threaded shank and an enlarged head, and a nut having a shank with a blind hole therein, the blind hole being internally threaded to threadingly receive the externally threaded shank of the screw. The nut has an enlarged head on an end of the shank opposite from an end with an opening of the blind hole. The enlarged head of the nut has an outer surface and an inner surface. A sealing member is disposed around the shank of the nut, and the shank of the nut extends out of and away from the inner surface of the enlarged head of the nut. The nut has a plated outer surface, and the inner surface comprises a depression surrounding the shank. The sealing member may be an o-ring, a washer, or a pre-applied composite sealer. The depression is an annular depression.

Additional aspects, embodiments, and details of the invention, all of which may be combinable in any manner, are set forth in the following detailed description of the invention.

### BRIEF DESCRIPTION OF THE DRAWINGS

The invention, together with further objects and advantages, may best be understood by reference to the following description taken in conjunction with the accompanying drawings, in the several Figures in which like reference numerals identify like elements, and in which:

FIG. 1 is a cross-sectional view of a two-component structure showing a fastener assembly according to one or more embodiments of the present invention.

FIG. 2 is an exploded perspective view of a disassembled fastener assembly according to one or more embodiments of the present invention.

FIG. 3 is a perspective view of an embodiment of the nut portion of the fastener assembly of FIG. 2.

FIG. 4 is a top and front view of a sealing member used in accordance with fastener assemblies according to the various embodiments of the present invention.

FIG. 5 is a top and front view of another sealing member used in accordance with fastener assemblies according to the various embodiments of the present invention.

### DETAILED DESCRIPTION OF THE PREFERRED EMBODIMENTS

As mentioned above, a new fastener assembly has been invented which provides a member having a thinner head that provides sufficient structural support and which is plated to protect it from environmental conditions. The invented fastener assemblies can be used, for example, under graphical overlays without wearing the overlays down as quickly. Additionally, the new assemblies may be used to reduce the width of a truck.

With these general principles in mind, one or more embodiments of the present invention will be described with the understanding that the following description is not intended to be limiting.

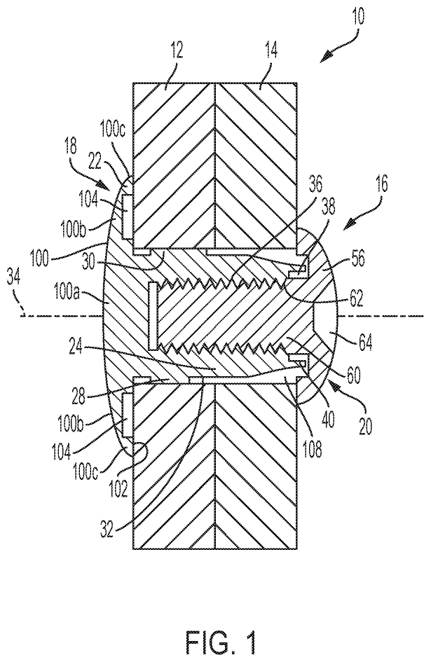

FIG. 1 illustrates a portion of a structure 10 (such as a container, portable shelter or truck body) in which a material forming a first structural component 12 such as a wall panel is secured to a second structural component 14 such as an extrusion by means of a plurality of fastener assemblies 16. Although only two layers of structural components are shown, any number of two or greater structural components may be secured together with the fastener assembly 16 of the present invention.

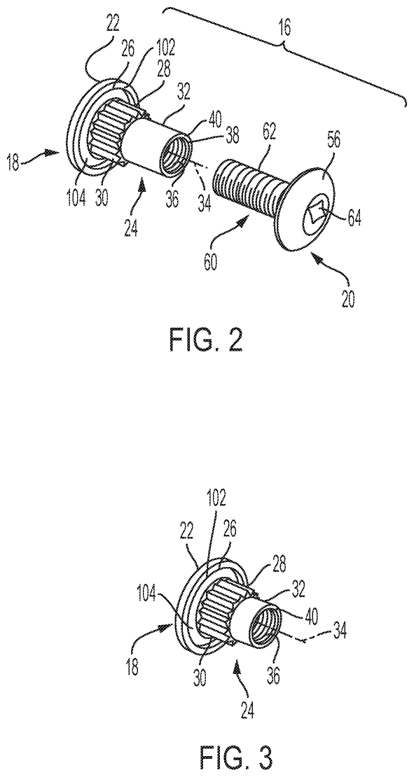

As shown in FIGS. 1 and 2, each of the fastener assemblies 16 includes a first fastener member 18 and a second fastener member 20. The first fastener member 18 may be in the form of a T-nut which includes a generally disc-shaped head portion 22. A generally cylindrical shank portion or post 24 is secured to, and extends away from, an inner surface 26 of the head portion 22. The shank portion 24 may be provided with an anti-rotation structure 28 in the form of a plurality of longitudinal ridges 30. The longitudinal ridges 30 are formed on a portion of the length of an outer peripheral surface 32 of the shank portion 24, and extend generally parallel to a longitudinal axis 34 of the shank portion 24. The longitudinal ridges 30 may have a constant height along their entire length.

The shank portion 24 is provided with an internally threaded longitudinal bore 36 comprising a blind hole with an opening 38 at a free end 40 opposite the head portion 22. The outer peripheral surface 32 of the shank portion 24 near the end 40 may have a smooth cylindrical shape with an outer diameter smaller than a width dimension of the anti-rotation structure 28.

At least an outer surface 100 of the head portion 22 is plated to protect the underlying material of the first fastener member 18 from corrosion. Preferably, the plated portion of the first fastener member 18 is rated for at least 1,000 hours of exposure, or 3,000 hours, or 6,000 hours, or 12,000 hours of exposure as determined by conventional salt stray analysis. Plating processes such as the ARMOUR PROTEK® and ARMOUR PROTEK ULTRA® are preferred.

As shown in FIGS. 2 and 3, an inner surface 102 of the head portion 22 of the first fastener member 18 includes a depression 104, preferably formed as an annular depression. The depression 104 surrounds the shank portion 24 to provide structural support for the head portion 22 which is thinner compared with conventional fastener assemblies.

Preferably, the distance between the inner surface 102 and outer surface of the head portion 22 is approximately 0.1 inches (+/−0.007). Additionally, the outer surface 100 preferably has a central portion 100a that is planar having a diameter of approximately 0.397 inches (+/−0.005). A tapering portion 100b surrounds the central portion 102a which thins out towards the outer edge 100c of the head portion 22. The thickness of the head portion 22 at the outer edge 100c is preferably approximately 0.030 inches (+/−0.005). The head portion 22 may have an overall diameter of approximately 0.850 inches (+/−0.039).

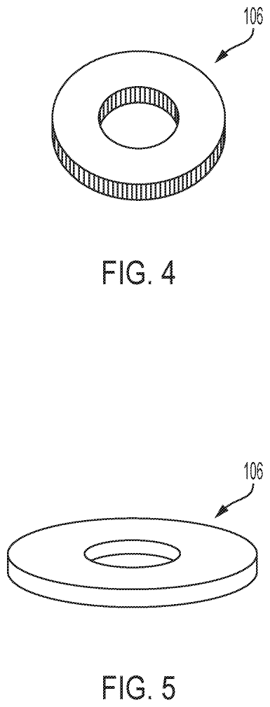

Turning to FIGS. 4 and 5, a sealing member 106, may be used with the fastener assembly 16 to form a seal with a bore 108 (see, FIG. 1) when the fastener assembly 16 is secured together in the structure 10. The seal prevents or at least minimizes the chance that water or other liquids penetrate the bore 66. The sealing member 106 may be an o-ring (FIG. 4) or a washer (FIG. 5) or pre-applied composite sealer.

Returning to FIGS. 1 and 2, the second fastener member 20, which may be a screw, is provided with a head portion 56 from which extends a generally cylindrical shank portion 60. The shank portion 60 is provided with external threads 62 that may extend along the entire length of the shank portion 60, and is adapted to threadingly engage with the internal bore 36 of the first fastener member 18. An outer side of the head portion 56 of the second fastener member 20 may be provided with a recessed portion 64 that is adapted to receive a tool for rotationally driving the second fastener member. The recessed portion 64 as shown is adapted to receive a TORX® or equivalent driving tool, but it is contemplated that the head portion 56 can be adapted or shaped to receive any suitable driving tool, such as a screwdriver, allen wrench or socket wrench.

In operation, the first fastener member 18 is inserted into a bore 66 in the structural component 12, as shown in FIG. 1. The bore 66 has a diameter that is slightly less than the diameter of the anti-rotational structure 28. The longitudinal ridges 30 frictionally engage the inner surface of the bore 66. The smooth cylindrical shape of the outer peripheral surface 32 of the shank portion 24 is smaller in diameter than the bore 66, allowing the first fastener member 18 to be easily inserted into the bore.

After the first fastener member 18 has been inserted into the first structural component 12, the second fastener member 20 is then inserted through an aligned bore 68 in the second structural component 14, and a driving tool is used to rotationally drive the second fastener member 20, thus causing the threaded shank portion 60 of the second fastener member to threadingly engage the threaded inner bore 36 of the first fastener member 18. The frictional engagement of the anti-rotation structure 28 with the inner surface of the bore 68 prevents rotational movement of the first fastener members 18 with respect to the bore 68 of the first structural component 12.

The triangular configuration of the longitudinal ridges 30 (see FIG. 2) also allows the first fastener members 18 to be non-destructively removed from the first structural component 12 upon application of a significant axial force. This advantage is particularly important in applications where disassembly and reassembly are required, such as in containers and portable shelters.

The present fastener assemblies 16 provide an assembly that is thinner and can be used on vehicles under graphics without wearing down the graphics. Additionally, the assemblies could be used in an environment which exposes the head to corrosive materials such as salt and water.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A fastener assembly for securing at least two materials together, the fastener assembly comprising:
a screw having an externally threaded shank and an enlarged head,
a nut having a shank with a blind hole therein, the blind hole being internally threaded to threadingly receive the externally threaded shank of the screw,
the nut having an enlarged head on an end of the shank opposite from an end with an opening of the blind hole, the enlarged head of the nut having an outer surface and an inner surface,
wherein the shank of the nut extends out of and away from the inner surface of the enlarged head of the nut, and
wherein the inner surface comprises a depression surrounding the shank.

2. The fastener assembly according to claim 1, wherein the depression is an annular depression.

3. The fastener assembly according to claim 1, wherein the shank comprises plurality of parallel longitudinal ridges extending parallel to a longitudinal axis of the shank.

4. The fastener assembly according to claim 3, further comprising a sealing member around the plurality of parallel longitudinal ridges.

5. The fastener assembly according to claim 4, wherein the sealing member comprises an o-ring, a washer, or a pre-applied composite sealer.

6. The fastener assembly according to claim 1, wherein at least the outer surface of the enlarged head of the nut comprises a plated surface.

7. A fastener assembly for securing at least two materials together, the fastener assembly comprising:
a screw having an externally threaded shank and an enlarged head,
a nut having a shank with a blind hole therein, the blind hole being internally threaded to threadingly receive the externally threaded shank of the screw,
the nut having an enlarged head on an end of the shank opposite from an end with an opening of the blind hole, the enlarged head of the nut having an outer surface and an inner surface,
wherein the shank of the nut extends out of and away from the inner surface of the enlarged head of the nut, and
wherein the nut comprises a plated outer surface.

8. The fastener assembly according to claim 7, wherein the shank comprises plurality of parallel longitudinal ridges extending parallel to a longitudinal axis of the shank.

9. The fastener assembly according to claim 8, further comprising a sealing member around the plurality of parallel longitudinal ridges.

10. The fastener assembly according to claim 9, wherein the sealing member comprises an o-ring, a washer, or a pre-applied composite sealer.

11. The fastener assembly according to claim 9, wherein the inner surface comprises a depression surrounding the shank.

12. The fastener assembly according to claim 11, wherein the depression is an annular depression.

13. A fastener assembly for securing at least two materials together, the fastener assembly comprising:
a screw having an externally threaded shank and an enlarged head,
a nut having a shank with a blind hole therein, the blind hole being internally threaded to threadingly receive the externally threaded shank of the screw, the nut having an enlarged head on an end of the shank opposite from an end with an opening of the blind hole, the enlarged head of the nut having an outer surface and an inner surface, and,
a sealing member disposed around the shank of the nut,
wherein the shank of the nut extends out of and away from the inner surface of the enlarged head of the nut, and
wherein the nut comprises a plated outer surface,
wherein the inner surface comprises a depression surrounding the shank.

14. The fastener assembly according to claim 13, wherein the sealing member comprises an o-ring, a washer, or a pre-applied composite sealer.

15. The fastener assembly according to claim 13, wherein the depression is an annular depression.
